(19) United States
(12) Patent Application Publication
(10) Pub. No.: US 2026/0242180 A1
(43) Pub. Date: Aug. 20, 2026

(54) ELEVATOR SYSTEM WITH TWO CARS AND TWO COUNTERWEIGHTS

(71) Applicant: TK ELEVATOR INNOVATION AND OPERATIONS GMBH, Düsseldorf (DE)

(72) Inventors: Holger Zerelles, Leinfelden Echterdingen (DE); Andreas Ayen, Neckartenzlingen (DE); Marc Hense, Neuhausen (DE)

(73) Assignee: TK ELEVATOR INNOVATION AND OPERATIONS GMBH, Düsseldorf (DE)

(21) Appl. No.: 19/160,590

(22) PCT Filed: Mar. 1, 2024
(86) PCT No.: PCT/EP2024/055394

§ 371 Date: Aug. 28, 2025

(30) Foreign Application Priority Data
Mar. 8, 2023 (DE) 10 2023 105 708.1

(51) Int. Cl. B66B 11/00

(52) U.S. Cl. CPC B66B 11/0095

(57) ABSTRACT

The present disclosure relates to an elevator system including an elevator shaft, a first car, a second car, a first counterweight connected to the first car via a first suspension member, and a second counterweight connected to the second car via a second suspension member, wherein the first counterweight and the second counterweight are guided one above the other in a first pair of guide rails. The first counterweight is arranged above the second counterweight. A first contact point of the second suspension member and a second contact point of the second suspension member are formed on the second counterweight. The first contact point is arranged in front of a plane spanned by the first pair of guide rails and the second contact point is arranged behind the plane spanned by the first pair of guide rails and the contact points lie opposite one another in a first diagonal direction.

### CROSS REFERENCE TO RELATED APPLICATIONS

This application is a U.S. national stage of International Application No. PCT/EP2024/055394, filed on Mar. 1, 2024, which in turn claims priority to German Patent Application No. 102023105708.1, filed on Mar. 8, 2023, the entire contents of which are hereby incorporated by reference in their entirety.

### TECHNICAL FIELD

The present disclosure generally relates to an elevator system for transporting persons and/or transported goods, and, more specifically to two elevator cars within a vertically extending elevator shaft and two different suspension members and counterweights connected between respective elevator cars.

### BACKGROUND

Elevator systems with several elevator cars movable and guided in the same elevator shaft are known from the prior art. Such elevator systems are sold, for example, by the applicant under the name “TWIN”, wherein the elevator cars are arranged one above the other. With such systems, a single elevator shaft can be utilized more efficiently compared to a single-car system, so that waiting times are shortened.

In known elevator systems, both with a single car and two cars movable independently of each other in an elevator shaft, it is known that the cars are each connected to a counterweight via suspension means. In elevator systems with two cars, the two counterweights are regularly guided on separate walls of the elevator shaft, for which the elevator shaft must provide sufficient installation space.

It is also known to guide a plurality of counterweights on the same wall of the elevator shaft, for example side by side or, as known from EP 1 935 828 A1 or JP S 59153773 A, one above the other, but these known solutions are structurally very complex and comprise a large number of components that have to be installed in the elevator shaft with high degree of positioning accuracy.

### SUMMARY

Based on the situation described above, it is a task of the present disclosure to propose a simplified elevator system with two cars and counterweights associated to the respective cars.

The task of the disclosure is achieved by the features of the independent main claims. Advantageous embodiments are indicated in the subclaims. Where technically possible, the teachings of the sub-claims can be combined as desired with the teachings of the main and sub-claims.

Accordingly, the task is solved in particular by an elevator system for transporting persons and/or transported goods, including a vertically extending elevator shaft, a first car movable along the elevator shaft, a second car movable along the elevator shaft, a first counterweight connected to the first car via a first suspension member and a second counterweight connected to the second car via a second suspension member, wherein the first counterweight and the second counterweight are guided one above the other in a first pair of guide rails, wherein the first counterweight is arranged above the second counterweight, wherein a first contact point of the second suspension member and a second contact point of the second suspension member are formed on the second counterweight and wherein the first contact point is arranged in front of a plane spanned by the first pair of guide rails and the second contact point is arranged behind the plane spanned by the first pair of guide rails and the contact point lie opposite one another in a first diagonal direction.

Advantageous aspects of the disclosure are explained below and embodiments of the disclosure are further described below. Explanations, in particular, of the advantages and definitions of features, are basically descriptive and preferred, but not limiting, examples. If an explanation is limiting, this is expressly mentioned.

Insofar as elements are designated with the aid of numbering, i.e. for example “first element”, “second element” and “third element”, this numbering is intended purely for differentiation in the designation and does not represent a dependency of the elements on one another or a mandatory sequence of the elements represents. This means in particular that, for example, a device or method does not have to have a “first element” in order to have a “second element”. The device or method can also have a “first element” and a “third element” without necessarily having a “second element”. Several units of an element of a single numbering can also be provided, for example several “first elements”.

An elevator shaft of the elevator system extends at least in sections in a vertical direction. The elevator shaft may have a clear cross-section that is filled by a single car so that the two cars cannot pass each other. Accordingly, the elevator cars are arranged below or above each other at all times. Appropriate safety devices may be utilized to ensure that the elevator cars cannot collide with each other and are sufficiently spaced apart at all times. The elevator shaft can also have a fallback position or parking position above a top floor and/or below a bottom floor, into which the corresponding top or bottom car can be moved in order to grant the other car access to the top or bottom floor.

A suspension member may be designed as a cable, belt, chain, or the like and bears tensile loads in the direction of its longitudinal extension. Several redundant suspension members can also be guided in parallel, wherein in such an arrangement all parallel-guided suspension members are included in the term “suspension member” used here or it is clear from the context if only an individual suspension member are meant.

For example, a respective suspension member is attached to the car at a first end, guided vertically to an associated drive in a machine room arranged at the head end of the elevator shaft, at which it is deflected and thereby driven, again guided vertically to the associated counterweight, and attached to the counterweight with a second end. This results in a 1:1 suspension. The end attachment to the counterweight and/or the car can be divided into two contact points or two parallel guided suspension member can be attached to the counterweight at different contact points.

Alternatively, a respective suspension member is attached to a suspension in the machine room or the shaft head at a first end and guided vertically from there to the associated elevator car. There, the suspension member is deflected and guided vertically to the associated drive in the machine room, where it is deflected and driven. From the drive, the suspension member then runs vertically to the associated counterweight, to which it is attached with a second end or is deflected again and guided vertically to a further shaft-side suspension. This results in a 2:1 suspension. Other alternative suspension ratios are familiar to those skilled in the art and are implicitly included in the present description.

A counterweight is usually of designed as a flat body, i.e. with the smallest possible depth, which is guided as close as possible in front of a wall of the elevator shaft on the first guide rails, so that the remaining cross-section of the elevator shaft remains for moving the cars and the cars can be designed accordingly with the largest possible floor plan in order to be able to accommodate as many persons or bulky goods as possible in the cars. Accordingly, counterweights are designed with comparatively large dimensions in height and/or width, so that they achieve a mass that is in the range of the empty mass of the associated car or higher. The counterweight therefore generally extends in the plane spanned by the first pair of guide rails with a small extension perpendicular to this plane, wherein the plane between the guide rails of the first pair of guide rails extends parallel to the wall of the elevator shaft. Thus, in so far as a first contact point is arranged in front of the plane spanned by the first pair of guide rails and the second contact point behind them, these are also located in front of or behind the respective counterweight.

A contact point is understood to be the point at which generally a vertical strand of the suspension member contacts the counterweight. This may be an attachment point of the suspension member on the counterweight, at which one end of the suspension member is firmly connected to the counterweight, or a contact point of the suspension member on a deflection pulley of the counterweight for deflecting the suspension member.

Insofar as the contact points lie opposite one another in a diagonal direction, a direct connecting line between the contact points extends diagonally to the plane spanned by the first pair of guide rails. Diagonal is understood to be an angular relationship greater than 0° and less than 90°. Insofar as two diagonal directions are oriented in opposite directions to each other, the said angular ratio is carried in different directions of rotation from the plane spanned by the first pair of guide rails. The two oppositely oriented diagonal directions are then, for example, perpendicular or at an approximately perpendicular angle to each other.

The elevator system described above thus now comprises the teaching that the first counterweight and the second counterweight are arranged or guided one above the other and in the same pair of guide rails, namely in the first pair of guide rails. In this way, a further pair of guide rails and the associated assembly in the elevator shaft can be dispensed with, so that the elevator system has fewer components, is less expensive and is also easier to assemble than elevator systems known from the conventional art. The aforementioned arrangement of the contact points for the second suspension member on the second counterweight allows the second suspension member to run in front of and behind the first counterweight arranged above the second counterweight and prevents mutual obstruction between the first counterweight and the second suspension member. The second suspension member is guided vertically parallel to the wall directly next to the first counterweight and is therefore arranged in the elevator shaft to protect space without obstructing other components of the elevator system.

The teaching includes the fact that there are always two contact points for the first suspension member on the second counterweight. These are either two attachment points for parallel strands of a two-part first lower cable or an infeed point and an outfeed point of one or more deflection pulleys at which a single second suspension member is deflected. In the case of a two-part second suspension member, the parts of the second suspension member can each be driven by the same drive or by separate drives.

In an embodiment of the elevator system, the second suspension member is guided transversely on the second counterweight between the first contact point and the second contact point by at least one deflection pulley. This makes it possible to arrange the contact points in front of and behind the plane spanned by the first pair of guide rails in a suspension that requires the second suspension member to be deflected on the second counterweight and thus to guide the second suspension member with sufficient distance to the first counterweight. In particular, the transverse guiding is carried out by a pair of deflection pulleys. The at least one deflection pulley is arranged, for example, on a frame of the second counterweight.

The first suspension member can be suspended from the first counterweight at just a single contact point in its center of gravity, especially with a 1:1 suspension, and can then be guided vertically between the first suspension member and the second suspension member in the elevator shaft without any risk of interference. In an alternative embodiment, a first contact point of the first suspension member and a second contact point of the first suspension member are formed on the first counterweight. The contact points can then also be positioned particularly favorably in the elevator shaft in order to avoid an obstruction between the first suspension member and other components of the elevator system, in particular the second suspension member, especially with a suspension ratio of 2:1 or higher.

In the first counterweight, in one embodiment, the first contact point and the second contact point are arranged in the plane spanned by the first pair of guide rails. Alternatively, the first contact point of the first suspension member is disposed in front of the plane spanned by the first pair of guide rails and the second contact point of the first suspension member is disposed behind the plane spanned by the first pair of guide rails and the contact point lie opposite to each other in a second diagonal direction oriented in the opposite direction to the first diagonal direction. In both cases it is achieved that the first suspension member can be guided vertically in the elevator shaft without obstructing the second suspension member.

In some aspects, the first suspension member of the first counterweight is also guided transversely between the first contact point and the second contact point using at least one deflection pulley. It is thus possible to position the contact points favorably on the first counterweight in the case of a suspension that requires deflection of the first suspension member on the first counterweight, in particular in front of and behind the plane spanned by the first pair of guide rails. The transverse guiding takes place by a pair of deflection pulleys. The at least one deflection pulley is arranged, for example, on a frame of the first counterweight.

In a further embodiment of the elevator system, the first counterweight is further connected to the first elevator car via a first lower cable, wherein a first contact point of the first lower cable and a second contact point of the first lower cable are formed on the first counterweight and wherein the first contact point is arranged in front of the plane spanned by the first pair of guide rails and the second contact point is arranged behind the plane spanned by the first pair of guide rails and the contact points lie opposite one another in a third diagonal direction oriented in the opposite direction to the first diagonal direction. The third diagonal direction can, for example, be parallel to the second diagonal direction, but can also deviate from the second diagonal direction. The first lower cable serves to keep the first suspension member under tension, especially in conjunction with a cable tensioning device. The term lower cable is to be understood as meaning that, in addition to an actual cable, it can also be another suspension member such as a belt, a chain or the like. In particular, the first lower cable corresponds in its nature to the first suspension member. The embodiment now includes the teaching that the first lower cable, which must be guided past the second counterweight, is attached to the first counterweight in a corresponding manner to the way in which the second suspension member is attached to the second counterweight. The first lower cable is therefore simply guided past the second counterweight and an obstruction between the first lower cable and the second counterweight is advantageously prevented.

The teaching includes that there are always two contact points for the first lower cable on the first counterweight. These are either two attachment points for a two-part first lower cable formed from parallel strands or an infeed point and an outfeed point of one or more deflection pulleys at which a single first lower cable is deflected.

In one embodiment, the first lower cable at which first counterweight is guided transversely between the first contact point and the second contact point by at least one deflection pulley. As such, it is possible to position the contact point favorably on the first counterweight in a suspension that requires deflection of the first lower cable on the first counterweight, especially in front of and behind the plane stretched by the first pair of guide rails. In particular, the transverse guiding is carried out by a pair of deflection pulleys. The at least one deflection pulley is arranged, for example, on a frame of the first counterweight.

In a further aspect, the second counterweight is further connected to the second elevator car by a second lower cable. The second lower cable may be a second counterweight and only a single contact point, such as in this center of gravity, will rise and is then vertically arguable between the first lower cable and the second lower cable in the elevator shaft without risk of interference. In an alternative aspect, a second counterweight is formed into a first contact point of the second lower cable and a second contact point of the second lower cable.

In an embodiment with two contact points for the second lower cable on the second counterweight, the first contact point and the second contact point are arranged, for example, in the plane spanned by the first pair of guide rails. Alternatively, the first contact point of the second lower cable is arranged in front of the plane spanned by the first pair of guide rails and the second contact point of the second lower cable is arranged behind the plane spanned by the first pair of guide rails and the contact point lies opposite one another in a fourth diagonal direction oriented opposite the third diagonal direction. The contact points for the second lower cable on the second counterweight can then also be positioned particularly favorably in the elevator shaft, for example to avoid an obstruction between the second lower cable and other components of the elevator system, in particular the first lower cable. The fourth diagonal direction can, for example, be parallel to the first diagonal direction, but can also deviate from the first diagonal direction.

In a further embodiment of the elevator system, the second lower cable is guided transversely on the second counterweight between the first contact point and the second contact point by at least one deflection pulley. As such, it is possible to position the contact point favorably on the second counterweight in a suspension that requires a deflection of the second lower cable on the second counterweight, especially in front of and behind the tarpaulin stretched by the first pair of guide rails. In particular, the transverse guiding is carried out by a pair of deflection pulleys. The at least one deflection pulley is arranged, for example, on a frame of the second counterweight.

In a further embodiment, the elevator system has at least one protection device for avoiding contact between the first counterweight and the second counterweight. The protection device is of designed in particular as a damper or as a braking device and includes, for example, a proximity sensor, and further the protection device can also counteract contact of at least one counterweight with one end of the elevator shaft.

In a further embodiment of the elevator system, the first car and the second car are guided one above the other in a second pair of guide rails, with the first car being arranged under the second elevator car. The advantage of assigning the lower car to the upper counterweight and vice versa in this way is that the first counterweight can be moved to an upper end of the elevator shaft when the first car is in its lowest position in the elevator shaft. Furthermore, by assigning both cars to the same second pair of guide rails, an additional guide rail is avoided, so that the elevator system is designed with few components and is particularly simple.

### BRIEF DESCRIPTION OF THE DRAWINGS

The present disclosure will be explained in more detail below with reference to the attached drawings using preferred exemplary embodiments. The formulation Figure is abbreviated in the drawings with Fig.

The drawings show:

FIG. 1 schematically depicts a view of an elevator system of an embodiment of the present disclosure;

FIG. 2a schematically depicts a front view of the counterweight of an elevator system according to an embodiment of the present disclosure;

FIG. 2b schematically depicts a top view of the counterweights of the elevator system according to FIG. 2a;

FIG. 3a schematically depicts a front view of the counterweights of an elevator system according to an embodiment of the present disclosure;

FIG. 3b schematically depicts a top view of the machine room and the counterweights of the elevator system according to FIG. 3a;

FIG. 3c schematically depicts a top view of the counterweight of the elevator system according to FIGS. 3a and 3b;

FIG. 4a schematically depicts a front view of the counterweights of an elevator system according to an embodiment of the present disclosure;

FIG. 4b schematically depicts a top view of the machine room and the counterweights of the elevator system according to FIG. 4a;

FIG. 4c schematically depicts a top view of the counterweights of the elevator system according to FIGS. 4a and 4b;

FIG. 5a schematically depicts a front view of the counterweights of an elevator system according to an embodiment of the present disclosure;

FIG. 5b schematically depicts a top view of the machine room and the counterweights of the elevator system according to FIG. 5a; and

FIG. 5c schematically depicts a top view of the counterweights of the elevator system according to FIGS. 5a and 5b.

### DETAILED DESCRIPTION OF THE DRAWINGS

The exemplary embodiments described are merely examples that can be modified and/or supplemented in a variety of ways within the scope of the claims. Each feature described for a particular embodiment can be used independently or in combination with other features in any other embodiment. Each feature that is described for an exemplary embodiment of a specific claim category can also be used in a corresponding manner in an exemplary embodiment of another claim category.

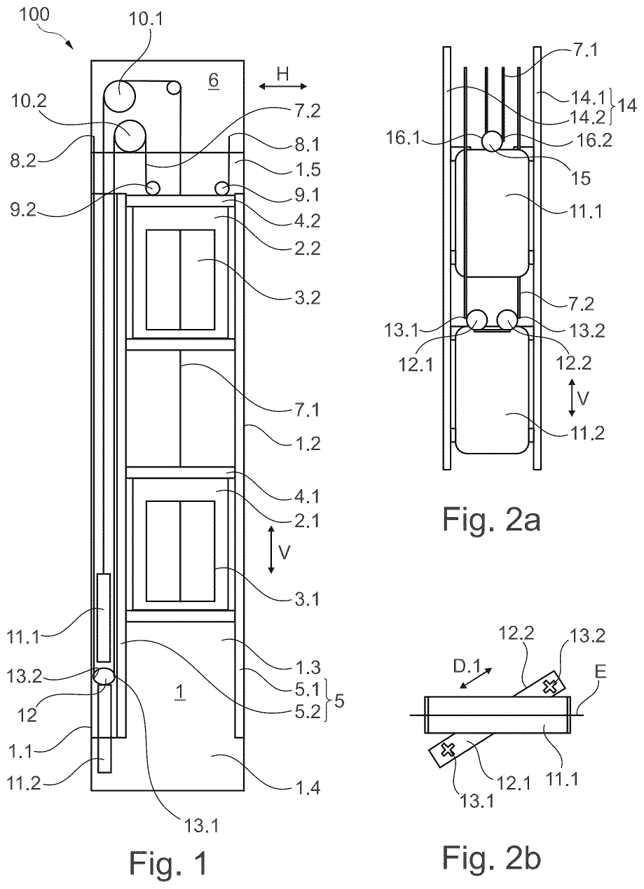

FIG. 1 shows an elevator system 100 in a first embodiment, viewed from the direction of a front wall. The elevator system 100 has an elevator shaft 1 which extends in a vertical direction V and has a first side wall 1.1, a second side wall 1.2, a rear wall 1.3 and the front wall, which is not shown. The elevator shaft 1 is closed off in the vertical direction V by a shaft pit 1.4 and a shaft head 1.5. A first elevator car 2.1 and a second elevator car 2.2 are arranged in the elevator shaft 1, whereby the first elevator car 2.1 is arranged below the second elevator car 2.2. A respective car 2.1, 2.2 has an access door 3.1, 3.2 and is held in a frame 4.1, 4.2. The frames 4.1, 4.2 each engage in guide rails 5.1, 5.2 of a second pair of guide rails 5 with guide means not shown in detail and are guided along the second pair of guide rails 5 in the elevator shaft 1. A machine room 6 is arranged above the elevator shaft 1.

To move the cars 2.1, 2.2 in the elevator shaft 1 in the vertical direction V, cars 2.1, 2.2 are driven via suspension members 7.1, 7.2. The first suspension member 7.1 is attached at a first end to the first elevator car 2.1 and runs upwards from there in the vertical direction V to the machine room 6. In the machine room 6, the first suspension member 7.1 is deflected and driven on a first drive 10.1 and then runs downwards again in the vertical direction V to a first counterweight 11.1, which is guided on the first side wall 1.1 in a first pair of guide rails not shown in detail in FIG. 1. The first elevator car 2.1 is therefore suspended in a 1:1 ratio.

The second suspension member 7.2 is attached at a first end to a first suspension 8.1 arranged in the machine room 6. From the first suspension 8.1, the second suspension member 7.2 is guided in the vertical direction V downwards to the second elevator car 2.2. Deflection pulleys 9.1, 9.2 are arranged on the second frame 4.2, wherein the second suspension member 7.2, coming from the first suspension 8.1, is deflected in the horizontal direction H on the first deflection pulley 9.1 and is guided transversely to the second deflection pulley 9.2. At the second deflection pulley 9.2, the second suspension member 7.2 is again deflected in the vertical direction V and guided to a second drive 10.2, by the deflection and driven. From the second drive 10.2, the second suspension member 7.2 is then guided downwards to a second counterweight 11.2, wherein the second counterweight 11.2 is guided on the first side wall 1.1 in the first pair of guide rails not shown in more detail in FIG. 1. On the second counterweight 11.2, the second suspension member 7.2 is deflected on a deflection pulley 12.1 and guided upwards to a second suspension 8.2 arranged in the machine room 6, where it is attached. The second car 2.2 is therefore suspended in a 2:1 ratio. The deflection pulley 12 is arranged on the second counterweight 11.2 in such a way that a first contact point 13.1 is arranged in front of a plane E of the counterweights 11.1, 11.2 spanned by the first pair of guide rails and a second contact point 13.2 is arranged behind it, i.e. between the first side wall 1.1 and the counterweights 11.1, 11.2. The second suspension member 7.2 is in this respect guided in front of and behind the first counterweight 11.1, as described in detail with reference to the following figures in several embodiments.

FIGS. 2a and 2b show a schematic view of an embodiment of the suspension of the counterweights 11.1, 11.2, wherein FIG. 2a shows a front view and FIG. 2b shows a top view. As in the embodiment shown in FIG. 1, the counterweights 11.1, 11.2 are guided one above the other in a first pair of guide rails 14 formed by the guide rails 14.1, 14.2, the first counterweight 11.1 being arranged above the second counterweight 11.2. Deflection pulleys 12.1, 12.2 are arranged on the second counterweight 11.2, which form contact points 13.1, 13.2, with the contact points 13.1, 13.2 opposing each other in a first diagonal direction D.1; The second suspension member 7.2 is therefore guided transversely between the deflection pulleys 12.1, 12.2 in the first diagonal direction D.1 So that the first contact point 13.1 is in front of a plane E spanned by the first pair of guide rails 14 and the second contact point 13.2 is behind the plane E. On the first counterweight 11.1, the first suspension member 7.1 is redirected by another deflection pulley 15, wherein through the deflection pulley 15 formed contact points 16.1, 16.2 lie in plane E.

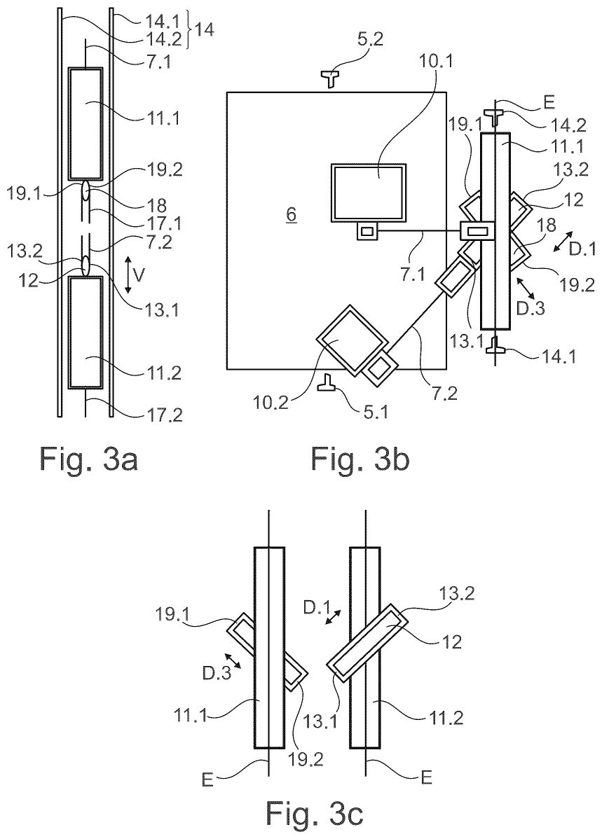

FIGS. 3a and 3b show diagrammatic views corresponding to FIGS. 2a, 2b of a further embodiment of the suspension of the counterweights 11.1, 11.2, wherein FIG. 3b further shows the machine room 6 with the drives 10.1, 10.2 arranged therein and the elevator shaft 1 with the guide rails 5.1, 5.2 arranged therein and FIG. 3 c additionally shows the counterweights 11.1, 11.2 individually in a top view. A repetitive explanation of aspects of the figures already described is omitted.

In the embodiment shown in FIGS. 3a to 3c, the second counterweight 11.2 has a deflection pulley 12 for redirecting the second suspension member 7.2, the deflection pulley 12 forming a first contact point 13.1 in front of the plane E and a second contact point 13.2 behind the plane E. The first suspension member 7.1 is attached to the first counterweight 11.1 in its center of gravity.

The elevator system 1 according to FIGS. 3a to 3c also includes a first lower cable 17.1 between the first elevator car 2.1 and the first counterweight 11.1 and a second lower cable 17.2 between the second elevator car 2.2 and the second counterweight 11.2. The first lower cable 17.1 is deflected on a deflection pulley 18 on the first counterweight 11.1 corresponding to the second suspension member 7.2, the deflection pulley 18 forming a first contact point 19.1 for the first lower cable 17.1 in front of the plane E and a second contact point 19.2 for the first lower cable 17.1 behind the plane E. The deflection pulley 18 guides the first lower cable 17.1 between the contact points 19.1, 19.2 transversely in a third diagonal direction D.3, the third diagonal direction D.3 being approximately perpendicular to the first diagonal direction D.1. The first lower cable 17.1 then runs in front of or behind the second counterweight 11.2 and further away from the second suspension member 7.2. The second lower cable 17.2 is attached to the second counterweight 11.2 at its center of gravity.

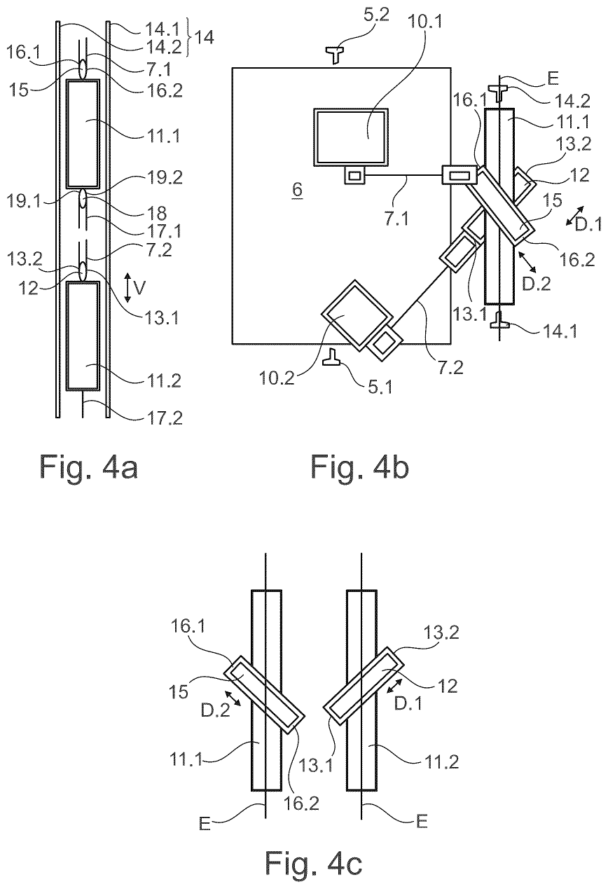

The embodiment of the suspension of the counterweights 11.1, 11.2 shown schematically in FIGS. 4a to 4c corresponds to the embodiment shown in FIGS. 3a to 3c, wherein the first suspension member 7.1 is suspended from the first counterweight 11.1 on a deflection pulley 15. The deflection pulley 15 forms a first contact point 16.1 for the first suspension member s 7.1 in front of the plane E and a second contact point 16.2 for the first suspension member 17.2 behind the plane E. The deflection pulley 15 thus guides the first suspension member 7.1 between the contact points 16.1, 16.2 transversely in a second diagonal direction D.2, wherein the second diagonal direction D.2 is approximately perpendicular to the first diagonal direction D.1. The first suspension member 7.1 runs away from the second suspension member 7.2. The second diagonal direction D.2 is still parallel to the third diagonal direction D.3, so that the deflection pulley 15 covers the deflection pulley 18 in the top view.

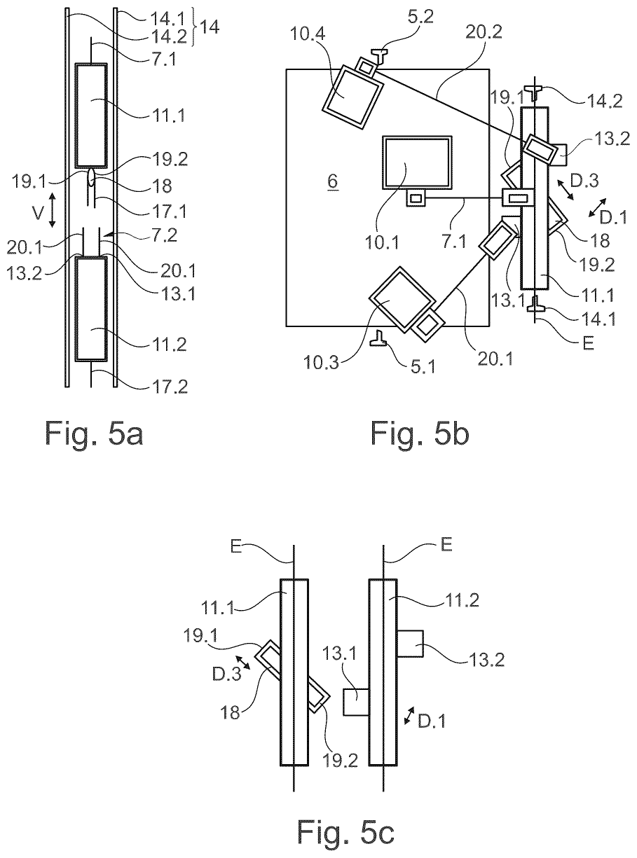

The embodiment of the suspension of the counterweights 11.1, 11.2 shown schematically in FIGS. 5a to 5c corresponds to the embodiment shown in FIGS. 3a to 3c, wherein the second suspension member 7.2 is formed from a first strand 20.1 and a second strand 20.2 guided parallel to the first strand 20.1. The first strand 20.1 is attached directly to the second counterweight 11.2 at the first contact point 13.1 and the second strand 20.2 is directly attached to the second contact point 13.2. The contact points 13.1, 13.2 are formed by projections on the second counterweight 11.2. In addition, a drive 10.3 is arranged in the machine room 6 for the first strand 20.1 and a drive 10.4 for the second strand 20.2, which are operated in particular in parallel or synchronously with one another.

1. An elevator system for transporting persons and/or transported goods, comprising
a vertically extending elevator shaft;
a first elevator car-moveable along the elevator shaft;
a second elevator car-moveable along the elevator shaft;
a first counterweight connected to the first car via a first suspension member; and
a second counterweight connected to the second car via a second suspension member;
wherein the first counterweight and the second counterweight are guided one above the other in a first pair of guide rails;
wherein the first counterweight is arranged above the second counterweight;
wherein a first contact point of the second suspension member and a second contact point of the second suspension member are formed on the second counterweight; and
wherein the first contact point is arranged in front of a plane spanned by the first pair of guide rails and the second contact point is arranged behind the plane spanned by the first pair of guide rails and the contact points lie opposite one another in a first diagonal direction.

2. The elevator system according to claim 1, wherein the second suspension member is guided transversely on the second counterweight between the first contact point and the second contact point by at least one deflection pulley.

3. The elevator system-according to claim 1, wherein a first contact point of the first suspension member and a second contact point of the first suspension member are formed on the first counterweight.

4. The elevator system according to claim 3, wherein the first contact point and the second contact point are arranged in the plane spanned by the first pair of guide rails.

5. The elevator system according to claim 3, wherein the first contact point is arranged in front of the plane spanned by the first pair of guide rails and the second contact point is arranged behind the plane spanned by the first pair of guide rails and the contact points lie opposite one another in a second diagonal direction oriented in the opposite direction to the first diagonal direction.

6. The elevator system according to claim 3, wherein the first suspension is guided transversely between the first contact point and the second contact point by at least one deflection pulley on the first counterweight.

7. The elevator system according to claim 1, wherein the first counterweight is further connected to the first elevator car via a first lower cable;
wherein a first contact point of the first lower cable and a second contact point of the first lower cable is formed on the first counterweight; and
wherein the first contact point-is arranged in front of the plane spanned by the first pair of guide rails and the second contact point is arranged behind the plane spanned by the first pair of guide rails and the contact points lie opposite one another in a third diagonal direction oriented in the opposite direction to the first diagonal direction.

8. The elevator system according to claim 7, wherein the first lower cable is guided transversely between the first contact point and the second contact point by at least one deflection pulley on the first counterweight.

9. The elevator system according to claim 1, wherein the second counterweight is further connected to the second car via a second lower cable.

10. The elevator system according to claim 9, wherein a first contact point of the second lower cable and a second contact point of the second lower cable is formed on the second counterweight.

11. The elevator system according to claim 10, wherein the first contact point and the second contact point are arranged in the plane spanned by the first pair of guide rails.

12. The elevator system according to claim 10, wherein the first contact point is arranged in front of the plane spanned by the first pair of guide rails and the second contact point is arranged behind the plane spanned by the first pair of guide rails and the contact points lie opposite one another in a fourth diagonal direction oriented in the opposite direction to the third diagonal direction.

13. The elevator system according to claim 10, wherein the second lower cable is guided transversely between the first contact point and the second contact point by at least one deflection pulley on the second counterweight.

14. The elevator system according to claim 1 further comprising:
at least one protective device for avoiding contact between the first counterweight and the second counterweight.

15. The elevator system according to claim 1, wherein the first car and the second car are guided one above the other in a second pair of guide rails; and
wherein the first car is arranged below the second car.
